(19) United States
(12) Patent Application Publication
(10) Pub. No.: US 2018/0186418 A1
(43) Pub. Date: Jul. 5, 2018

(54) Bicycle Kick Stand Stabilizing Device

(71) Applicant: Daniel L. Parrish, JR., Pensacola, FL (US)

(72) Inventor: Daniel L. Parrish, JR., Pensacola, FL (US)

(21) Appl. No.: 15/856,319

(22) Filed: Dec. 28, 2017

Related U.S. Application Data
(60) Provisional application No. 62/441,641, filed on Jan. 3, 2017.

(51) Int. Cl. B62H 1/02

(52) U.S. Cl. CPC B62H 1/02

(57) ABSTRACT

A stabilizing device for use in stabilizing a bicycle having a kickstand pivotally movable between a stored configuration displaced from a ground surface and a deployed configuration proximate the ground surface includes a stabilizing member including a bottom side having a planar surface for engaging the ground surface and a top side opposite the bottom side for receiving a tip end of the kickstand at the deployed configuration. The top side of the stabilizing member includes a receiving area defining a channel configured to receive the tip end of the kickstand therein. The receiving area may include an upstanding continuous defining an interior area for capturing the kickstand.

### REFERENCE TO RELATED APPLICATIONS

This application claims the benefit of provisional patent application U.S. Ser. No. 62/441,641 filed Jan. 3, 2017 titled Bicycle Foot Pal and which is incorporated herein by reference.

### BACKGROUND OF THE INVENTION

This invention relates generally to bicycle accessories and, more particularly, to stabilizing device for use in supporting a kickstand of a bicycle atop wet, soft, or even saturated ground surfaces. In other words, the present invention prevents the tip end of a bicycle kickstand from sinking or digging in to wet ground.

A kickstand is a metal rod that is pivotally mounted to a bicycle frame which remains horizontal and close to the frame when the bicycle is ridden but which may be kicked downwardly to act to support the bicycle in a generally upright position when the bicycle is not in used, i.e. when the bike is “parked.” The kickstand works great so long as the terrain upon which the bicycle is being parked is firm, dry, and not such that the kickstand is prone to sink in. Of course, if the kickstand were to sink into the ground, such as if the ground is wet or sandy, the bicycle will fall over.

Therefore, it would be desirable to have a stabilizing device that may be positioned on the ground and which prevents the tip end of a bicycle kickstand from sinking into soft soil. Further, it would be desirable to have a stabilizing device that includes a receiving area specifically configured to receive the tip end of a bicycle in a secure, nested relationship.

### SUMMARY OF THE INVENTION

A stabilizing device according to the present invention for use in stabilizing a bicycle having a kickstand pivotally movable between a stored configuration displaced from a ground surface and a deployed configuration proximate the ground surface includes a stabilizing member including a bottom side having a planar surface for engaging the ground surface and a top side opposite the bottom side for receiving a tip end of the kickstand at the deployed configuration. The top side of the stabilizing member includes a receiving area defining a channel configured to receive the tip end of the kickstand therein. The receiving area may include an upstanding continuous defining an interior area for capturing the kickstand.

Therefore, a general object of this invention is to provide a stabilizing device for receiving the tip of a kickstand of a bicycle so as to stabilize and inhibit the bicycle from falling over when parked on uneven or saturated ground.

Another object of this invention is to provide a stabilizing device, as aforesaid, which has a “footprint” that is significantly larger and flatter that the tip end of a kickstand so as not to sink or dig in to moist soil.

Still another object of this invention is to provide a stabilizing device, as aforesaid, that may be kept in a bag and hung from a bicycle's handlebars until needed.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1a is a perspective view of a stabilizing device in use with a bicycle having a kickstand according to a preferred embodiment of the present invention;

FIG. 1b is an enlarged view on an enlarged scale taken from FIG. 1a and illustrating the stabilizing device;

FIG. 2 is a perspective view of the stabilizing device according to the present invention not in use with a bicycle;

FIG. 3 is a top view of the stabilizing device as in FIG. 2; and

FIG. 4 is a side view of the stabilizing device as in FIG. 2.

### DESCRIPTION OF THE PREFERRED EMBODIMENT

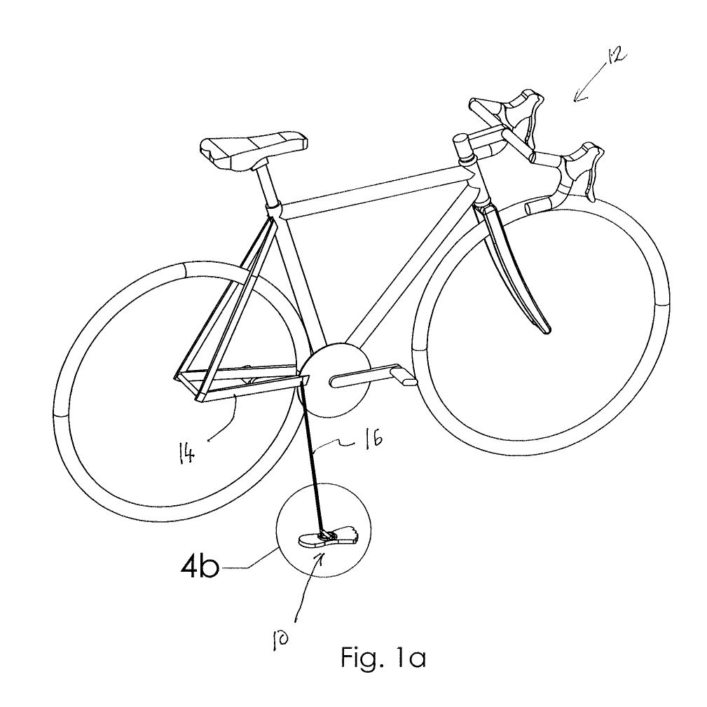

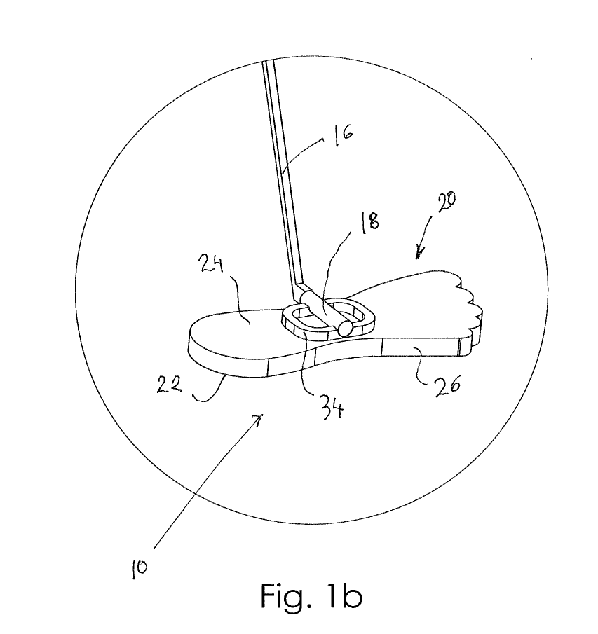

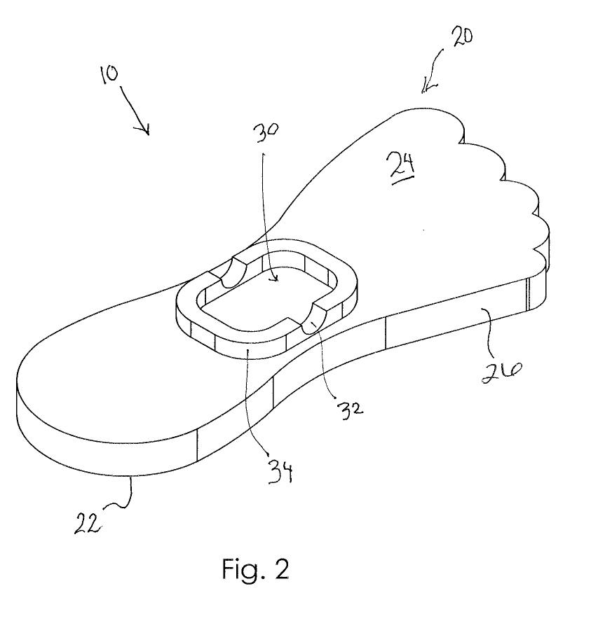

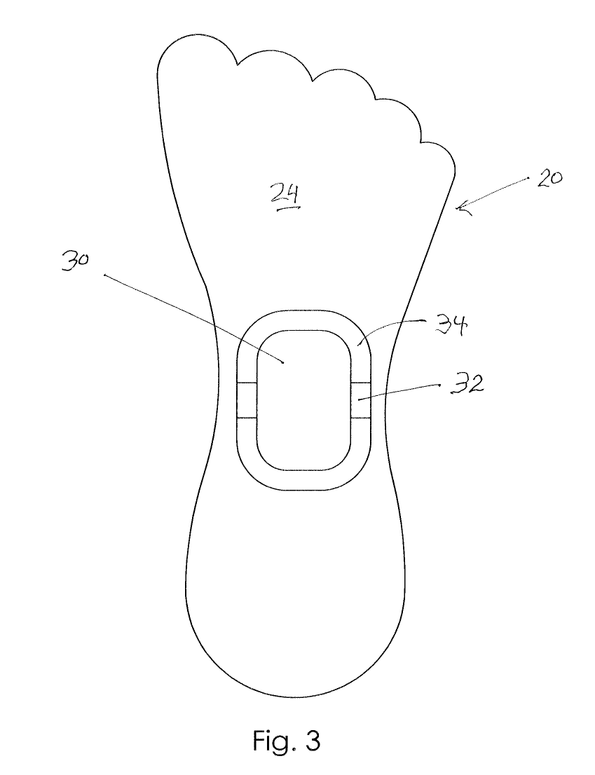

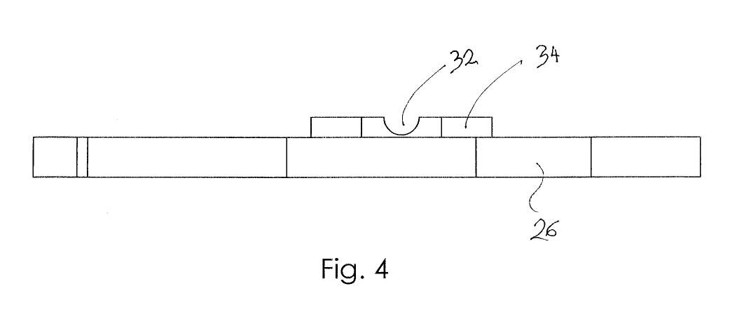

A bicycle kickstand stabilizing device according to a preferred embodiment of the present invention will be described with reference to FIGS. 1a to 4 of the accompanying drawings. The stabilizing device 10 includes a stabilizing member 20 having a receiving area 30 that includes a channel 32 for receiving a tip end 18 of a kickstand 16 in a nested configuration.

The stabilizing device 10 is intended for use in receiving the tip end 18 of a kickstand 16 that is pivotally coupled to a frame 14 of a bicycle 12 (FIG. 1a). It is understood that a traditional kickstand is pivotally movable on a bicycle 12 between a stowed configuration parallel or adjacent the frame 14 of the bicycle 12 and a deployed configuration extending toward a ground surface where it enables the bicycle to lean yet remain upright. It is understood that the stabilizing device 10 according to the present invention may be used with any variety of bicycle kickstand or may be manufactured in conjunction with a custom kickstand and be sold together in the manner of a kit.

The stabilizing device 10 includes a stabilizing member 20 having a bottom side 22 and an opposed top side 24, the bottom and top sides being parallel to one another and having flat or planar surfaces. The stabilizing member 20 may include side walls connecting the top and bottom sides and defining a thickness. The stabilizing member 20 may be molded or otherwise formed in various shape configurations, including being indicative of an anatomical foot of a person or animal. Preferably, the stabilizing member 20 has a length dimension that is at least two times and preferably three (3) times longer than its shortest width dimension so as to enhance stability while also being storable and portable in a bag. In addition, the width of the stabilizing member 20 should be at least as wide as a length of the tip end 18 of the kickstand 16 as best shown in FIG. 1b. As the tip end 18 of the kickstand 16 has a linear configuration, it may be received into the channel 32 of the receiving area 30 defined by the top side 24 of the stabilizing member 20 as described below. The bottom side 22 has a geographic area (length times width) that is larger than a geographic area of the tip end 18 of the kickstand 16 alone and, preferably, much larger so as to support the kickstand 16 on moist, saturated, or granular surfaces (e.g. sand).

The top side 24 of the stabilizing member 20 has a receiving area 30 that defines or forms a channel 32 capable of selectively receiving the tip end 18 of the kickstand 16 when the kickstand 16 is moved to the deployed configuration. As described above, the tip end 18 of the kickstand 16 may have a linear configuration complementary to that of the channel 32 so as to be received therein in a nested relationship (FIG. 1b). Preferably, the channel 32 extends between opposed side walls 26 of the stabilizing member 20. Accordingly, the channel 32 defines an imaginary transverse axis across the top side 24 of the stabilizing member 20 into which the tip end 18 of the kickstand 16 may be received.

In an embodiment, the channel 32 may be recessed or inset into the top side 24 of the stabilizing member 20. However, as illustrated, the receiving area 30 may include a boundary wall 34 (also referred to as an upstanding boundary wall) extending upwardly from the top side 24 of the stabilizing member 20. The boundary wall 34 may be a continuous side wall—meaning it may have a singular or unitary construction or have no corners. As such, the boundary wall 34 may have an oval or circular configuration or even a rectangular configuration with rounded or unbroken corners. The boundary wall 34 defines an interior area for capturing and containing the tip end 18 of a kickstand 16 regardless if the tip end 18 is nested in the channel 32.

In use, the stabilizing device 10 of the present invention may be stored in a bag or case and hung from the handlebars of a bicycle 12 until needed. For instance, if a bicyclist finds himself on sandy, rocky, uneven, wet, moist, or even saturated ground when ready to park the bicycle, the bicyclist may position the stabilizing member 20 on the ground and then deploy the kickstand 16 to rest against the stabilizing member 20 (FIG. 1a).

It is understood that while certain forms of this invention have been illustrated and described, it is not limited thereto except insofar as such limitations are included in the following claims and allowable functional equivalents thereof.

1. A stabilizing device for use in stabilizing a bicycle having a kickstand pivotally movable between a stored configuration displaced from a ground surface and a deployed configuration proximate the ground surface, said stabilizing device comprising:
a stabilizing member including a bottom side having a planar surface for engaging the ground surface and a top side opposite said bottom side for receiving a tip end of the kickstand at the deployed configuration;
wherein said top side of said stabilizing member includes a receiving area defining a channel configured to receive the tip end of the kickstand therein.

2. The stabilizing device as in claim 1, wherein said top side of said stabilizing member includes a width dimension that is at least equal to a length dimension of the tip end of the kickstand and includes a length dimension that is at least twice as large as a length dimension of the tip end of the kickstand.

3. The stabilizing device as in claim 1, wherein said bottom side of said stabilizing member defines a geographic area that is larger than a geographic area defined by the tip end of the kickstand.

4. The stabilizing device as in claim 1, wherein said channel defines an imaginary transverse axis extending between side walls of said stabilizing member, said channel configured to receive the tip end of the kickstand in said imaginary transverse axis.

5. The chair stabilizing device as in claim 1, wherein:
the tip end of the kickstand has a linear configuration;
said channel has a linear configuration for receiving the tip of the kickstand in a nested relationship.

6. The chair stabilizing device as in claim 1, wherein said receiving area includes a boundary wall extending upwardly from and perpendicular to said top surface, said channel cutting through opposed sections of said side wall.

7. The chair stabilizing device as in claim 1, wherein said receiving area includes a continuous side wall defining an interior area for receiving the tip end of the bicycle.

8. The chair stabilizing device as in claim 7, wherein said continuous side wall has one of a rectangular configuration or an oval configuration.

9. The chair stabilizing device as in claim 1, wherein a length defined by said stabilizing member is at least three times a smallest width of said stabilizing member for enhanced stability when the kickstand is at the deployed configuration.

10. The chair stabilizing device as in claim 7, wherein said continuous side wall includes opposed sections adjacent side walls of said stabilizing member having recesses, respectively, that define said channel.

11. A stabilizing device for use in stabilizing a bicycle, comprising:
a kickstand pivotally coupled to a frame of the bicycle and movable between a stored configuration displaced from a ground surface and a deployed configuration proximate the ground surface;
a stabilizing member including a bottom side having a planar surface for engaging the ground surface and a top side opposite said bottom side for receiving a tip end of the kickstand at the deployed configuration;
wherein said top side of said stabilizing member includes a receiving area defining a channel configured to receive the tip end of the kickstand therein.

12. The stabilizing device as in claim 11, wherein said kickstand includes a proximal end for attachment to the bicycle and a tip end opposed to said proximal end, said tip end having a linear configuration received in said channel in a nested relationship when said kickstand is at said deployed configuration.

13. The stabilizing device as in claim 12, wherein said top side of said stabilizing member includes a width dimension that is at least equal to a length dimension of the tip end of the kickstand and includes a length dimension that is at least twice as large as a length dimension of the tip end of the kickstand.

14. The stabilizing device as in claim 13, wherein said bottom side of said stabilizing member defines a geographic area that is larger than a geographic area defined by the tip end of the kickstand.

15. The stabilizing device as in claim 11, wherein said channel defines an imaginary transverse axis extending between side walls of said stabilizing member, said channel configured to receive the tip end of the kickstand in said imaginary transverse axis.

16. The chair stabilizing device as in claim 11, wherein said receiving area includes a boundary wall extending upwardly from and perpendicular to said top surface, said channel cutting through opposed sections of said side wall.

17. The chair stabilizing device as in claim 11, wherein said receiving area includes a continuous side wall defining an interior area for receiving the tip end of the bicycle.

18. The chair stabilizing device as in claim 17, wherein said continuous side wall has one of a rectangular configuration or an oval configuration.

19. The chair stabilizing device as in claim 17, wherein said continuous side wall includes opposed sections adjacent side walls of said stabilizing member having recesses, respectively, that define said channel.

20. The chair stabilizing device as in claim 11, wherein a length defined by said stabilizing member is at least three times a smallest width of said stabilizing member for enhanced stability when the kickstand is at the deployed configuration.
